(19) United States
(12) Patent Application Publication
(10) Pub. No.: US 2025/0306295 A1
(43) Pub. Date: Oct. 2, 2025

(54) DETACHABLE OPTICAL CONNECTOR WITH INTEGRATED STRAIN RELIEF FEATURES

(71) Applicant: Intel Corporation, Santa Clara, CA (US)

(72) Inventors: Wesley MORGAN, Lake Oswego, OR (US); Benjamin DUONG, Phoenix, AZ (US); David LATHAM, Chandler, AZ (US); Fan FAN, Chandler, AZ (US); Srikant NEKKANTY, Chandler, AZ (US)

(21) Appl. No.: 18/620,717

(22) Filed: Mar. 28, 2024

(51) Int. Cl. G02B 6/38

(52) U.S. Cl. CPC G02B 6/3887; G02B 6/387; G02B 6/3897

(57) ABSTRACT

Embodiments disclosed herein comprise an apparatus with a housing and a first opening at a first end of the housing and a second opening at a second end of the housing. In an embodiment, a ferrule is within the housing, and the ferrule comprises a plurality of holes. In an embodiment, a plurality of fibers are in the housing, and individual ones of the plurality of fibers are inserted into different ones of the plurality of holes in the ferrule. In an embodiment, a shim is provided across the plurality of fibers, and a third opening is in the housing, where the third opening is over the shim.

### BACKGROUND

Transmitting data over optical connections has been of growing importance in computing systems. For example, large amounts of data can be propagated along long lines with relatively minimal losses, especially compared to transmission of similar distances on electrical pathways. Accordingly, optical transmission of data has become the main solution for data transfer in server farms.

Fiber connectors are used to connect the optical fibers to the optoelectronic systems. In some instances the fiber connectors are detachable in order to enable easy reconfiguration, upgrading, and/or repair. Some connectors terminate individual optical fibers (e.g., glass fibers) at a glass ferrule. The glass ferrule aligns and positions the ends of the fibers with an optical bridge of a photonic integrated circuit (PIC) or the like. As can be appreciated, alignment accuracy between the ferrule and the optical bridge is critical to maintain high optical coupling efficiency. One risk is that after alignment has been properly made, accidently bumping or other force applied to the fibers can result in the shifting of the ferrule.

### BRIEF DESCRIPTION OF THE DRAWINGS

FIG. 1 is a cross-sectional illustration of an optoelectronic system with a board mounted strain relief clamp.

FIG. 2A is a perspective view illustration of a ferrule within a holder being coupled to an optical bridge, in accordance with an embodiment.

FIG. 2B is a perspective view of the ferrule and holder after being attached to the optical bridge, in accordance with an embodiment.

FIG. 3A is a perspective view illustration of a connector with a screw for strain relief, in accordance with an embodiment.

FIG. 3B is an exploded view of the connector in FIG. 3A, in accordance with an embodiment.

FIG. 3C is a cross-sectional illustration of a connector before the screw is inserted into the housing, in accordance with an embodiment.

FIG. 3D is a cross-sectional illustration of the connector in FIG. 3C after the screw is inserted in order to provide a force against a shim and the fibers within the housing, in accordance with an embodiment.

FIG. 3E is a cross-sectional illustration of a connector before the screw is inserted into the housing, where the screw opening is not over a portion of the latch spring, in accordance with an embodiment.

FIG. 3F is a cross-sectional illustration of the connector in FIG. 3E after the screw is inserted in order to provide a force against a shim and fibers within the housing, in accordance with an embodiment.

FIG. 4A is a perspective view illustration of a connector with a cam for strain relief, in accordance with an embodiment.

FIG. 4B is a perspective view illustration of the connector in FIG. 4A after the cam is engaged, in accordance with an embodiment.

FIG. 4C is an exploded view of the connector in FIG. 4B, in accordance with an embodiment.

FIG. 4D is a cross-sectional illustration of the connector with a cam for strain relief that is not engaged, in accordance with an embodiment.

FIG. 4E is a cross-sectional illustration of the connector with the cam for strain relief after the cam is engaged, in accordance with an embodiment.

FIG. 4F is a cross-sectional illustration of a connector with a cam that is not provided over a portion of the latch spring, in accordance with an embodiment.

FIG. 5 is a perspective view illustrations of an optoelectronic system with optical fibers coupled to a PIC through the use of a connector that includes a strain relief screw, in accordance with an embodiment.

FIG. 6 is a process flow diagram of a process for coupling a fiber connector to a photonics device with the use of a strain relief component integrated into the fiber connector, in accordance with an embodiment.

FIG. 7 is a schematic of a computing device built in accordance with an embodiment.

### DETAILED DESCRIPTION

Described herein are optoelectronic systems, and more particularly, detachable optical connectors with integrated strain relief features, in accordance with various embodiments. In the following description, various aspects of the illustrative implementations will be described using terms commonly employed by those skilled in the art to convey the substance of their work to others skilled in the art. However, it will be apparent to those skilled in the art that the present disclosure may be practiced with only some of the described aspects. For purposes of explanation, specific numbers, materials and configurations are set forth in order to provide a thorough understanding of the illustrative implementations. However, it will be apparent to one skilled in the art that the present disclosure may be practiced without the specific details. In other instances, well-known features are omitted or simplified in order not to obscure the illustrative implementations.

Various operations will be described as multiple discrete operations, in turn, in a manner that is most helpful in understanding the present disclosure, however, the order of description should not be construed to imply that these operations are necessarily order dependent. In particular, these operations need not be performed in the order of presentation.

Various embodiments or aspects of the disclosure are described herein. In some implementations, the different embodiments are practiced separately. However, embodiments are not limited to embodiments being practiced in isolation. For example, two or more different embodiments can be combined together in order to be practiced as a single device, process, structure, or the like. The entirety of various embodiments can be combined together in some instances. In other instances, portions of a first embodiment can be combined with portions of one or more different embodiments. For example, a portion of a first embodiment can be combined with a portion of a second embodiment, or a portion of a first embodiment can be combined with a portion of a second embodiment and a portion of a third embodiment.

Detachable optical connectors used in optical data transmission networks typically comprise a ferrule that is coupled to the ends of optical fibers (e.g., glass fibers) within a fiber bundle. The fibers are typically glued to the ferrule with an epoxy or the like. Accordingly, any movement of the fiber bundle outside of the connector can result in displacement of the ferrule as well. Displacement of the ferrule is problematic, since the ferrule needs to have accurate alignment with the optical bridge of the corresponding photonics integrated circuit (PIC) or other photonic device or component. For example, any amount of tilting, shifting, rotating, etc. can result in optical disengagement with the optical bridge.

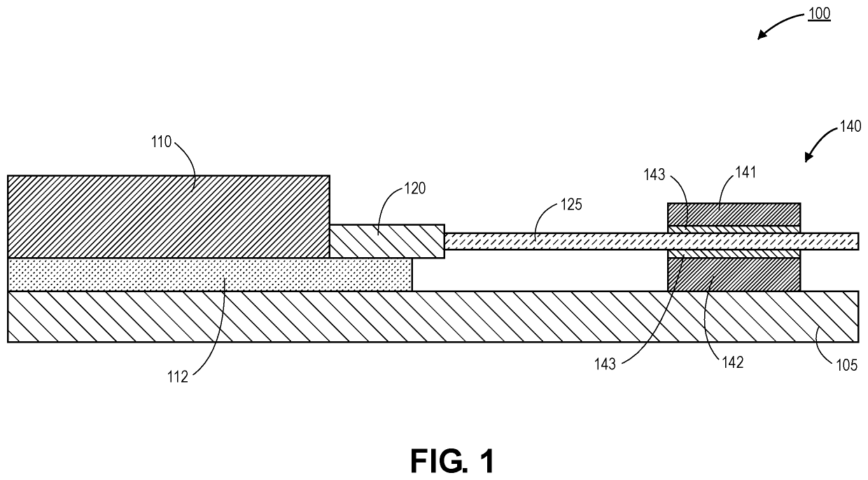

In order to prevent fiber induced displacement of the ferrule, strain relief structures have been proposed. An example of one such strain relief structure 100 is shown in FIG. 1. Referring now to FIG. 1, a PIC 110 is provided on a package substrate 105 or a board, such as a printed circuit board (PCB). An integrated heat spreader (IHS) 112 or any other interposing substrate may be provided between the PIC 110 and the package substrate 105. In an embodiment, a connector 120 is provided on the IHS 112 and is optically coupled with the PIC 110. In FIG. 1 the optical coupling between the connector 120 and the PIC 110 is not shown in detail. A more detailed explanation of the coupling of a connector 120 to the PIC 110 through an optical bridge will be described in greater detail below.

In FIG. 1, a fiber 125 extends out the back end of the connector 120 towards an edge of the package substrate 105. While a single fiber 125 is shown, it is to be appreciated that a plurality of fibers 125 may be coupled to the PIC 110 through the connector 120. A strain relief feature 140 is provided on the package substrate 105. The strain relief feature 140 includes a base 142 and a clamping feature 141 over the fiber 125. Compressible layers 143 may be provided between the base 142 and the fiber 125 and between the clamping feature 141 and the fiber 125. In an embodiment, the clamping feature 141 may be compressed against the fiber 125. This secures the fiber 125 within the strain relief feature 140. Accordingly, any movement, displacement, etc. of the fiber 125 to the right of the strain relief feature 140 will not transfer to the ferrule (not shown) within the connector 120.

However, such a solution has several drawbacks. First, the strain relief feature 140 is bulky and occupies valuable real estate on the surface of the package substrate 105. Additionally, the distance between the strain relief feature 140 and the connector 120 may still be significant. As such, the length of the fiber 125 between the strain relief feature 140 and the connector 120 may still be susceptible to being bumped, moved, or the like. That is, the package substrate mounted strain relief feature 140 may still result in suboptimal optical coupling with the PIC 110 in some instances.

In order to avoid such problems with package substrate 105 mounted strain relief features 140, some proposals have suggested permanently securing the fiber 125 to the housing of the connector 120. Theoretically, this allows for all fiber strain outside of the connector to be decoupled from the ferrule. However, permanently coupling the fiber 125 to the housing creates connector assembly difficulties, and makes coupling with the optical bridge difficult. Assembly is complicated with such a solution since it is difficult to control epoxy or glue flow while securing the fibers to the housing. For example, the epoxy may flow to other regions within the housing and prevent movement of components that need to move in order to enable coupling with the optical bridge (e.g., springs, the ferrule, latch spring, etc.). Even if the epoxy flow is properly controlled, fixing the fibers such a short distance from the ferrule results in very stiff fibers. The high column force of the stiff fibers can require an unacceptably high mating force.

Accordingly, embodiments disclosed herein include a connector design that allows for coupling with the optical bridge without the fibers being held at a fixed position within the connector. After the connector is coupled to the optical bridge, a strain relief feature is engaged to fix the position of the fibers within the connector. This provides the benefits of a low mating force for coupling, while also preventing optical misalignment of the ferrule due to strain on the fibers from outside of the connector. In an embodiment, the strain relief feature may comprise an actuator that applies a force to a shim, and the shim transfers the force to the fibers to fix them in place. As used herein, a “shim” may refer to a solid structure that is capable of transferring a force from a first object to a second objection. For example, a shim may be a rectangular prism or any other three-dimensional shape that can span across a plurality of fibers. That is, while the shims illustrated herein are rectangular prisms, embodiments are not limited to such shapes. A shim may include a plastic material, a metallic material, a ceramic material, a composite material, or any other suitable material for transferring force. From an actuator to a plurality of fibers.

In an embodiment, the strain relief feature is integrated directly into the connector. One embodiment may include a screw that passes through the housing. As the screw is tightened, the screw will apply a force on a shim that extends across the fibers within the housing. The shim evenly distributes the force across all fibers, and fixes all of the fibers in place. In other embodiments, the strain relief feature may include a cam. When the cam is not engaged, there is no additional force applied on the fibers. After the cam is engaged (e.g., by pulling a lever) the cam exerts a force on a shim that extends across the fibers, similar to the screw embodiment. As such, all of the fibers can be fixed in place. While screws and cams are provided as two specific examples, it is to be appreciated that other mechanical structures may also be used. For example, a wedge may be inserted between the housing and a shim in order to exert a force on the fibers. Other embodiments may include a magnetic shim. After coupling, an opposing magnet may be applied on the opposite side of the fibers from the magnetic shim in order to fix the fibers in place within the housing.

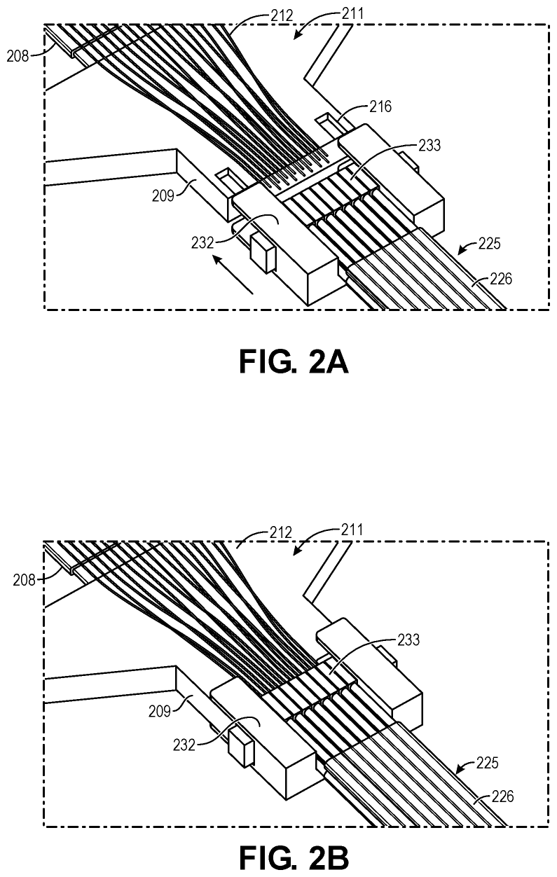

Referring now to FIG. 2A, a perspective view illustration of an optical bridge 211 that is to be coupled to a ferrule 233 is shown, in accordance with an embodiment. In the illustrated embodiment, the ferrule 233 is shown as being retained by a holder 232. The housing of the coupler around the ferrule 233 and the holder 232 is omitted for clarity. In an embodiment, the optical bridge 211 may comprise a glass material or any other suitable material. The optical bridge 211 may comprise a plurality of waveguides 212. Ends of the waveguides 212 may terminate at a surface of a tab 209 that is used for coupling to the connector. In an embodiment, the tab 209 may include alignment features. For example, slots 216 may be provided into the top and/or bottom surfaces of the tab 209. The slots 216 may be engaged by protrusions (not shown) on the holder 232. In an embodiment, the opposite ends of the waveguides 212 may terminate at the PIC 208. For example, the waveguides 212 may sit in V-grooves of the PIC 208. In an embodiment, the waveguides 212 start in two stacked rows at the face of the tab 209 and spread into a single row at the PIC 208.

In an embodiment, the ferrule 233 may comprise glass. The ferrule 233 may include holes for receiving the plurality of fibers 226 within a fiber bundle 225. The fiber bundle 225 may include a stack of two rows of fibers. Though, additional rows of fibers 226 or one row of fibers 226 may be used in other embodiments. The optical bridge 211 may have a matching number of rows of waveguides 212, and the ferrule 233 may have a matching number of rows of holes to accommodate the arrangement of the fiber bundle 225. In an embodiment, the ferrule 233 is held by the holder 232. The holder may secure the ferrule 233 and provide the proper alignment with the optical bridge 211 through the use of alignment features (e.g., slots 216 on the optical bridge 211 and corresponding protrusions (not visible) on the holder 232. In FIG. 2A, the holder 232 is aligned with the optical bridge 211 for coupling.

Referring now to FIG. 2B, a perspective view illustration of the optical bridge 211 and the ferrule 233 after coupling is shown, in accordance with an embodiment. As shown, the arms of the holder 232 have passed over the top and bottom of the optical bridge 211 on both sides of the ferrule 233. The protrusions (not visible) under the arms of the holder 232 have engaged the slots 216 in order to provide proper alignment between the ferrule 233 and the waveguides 212.

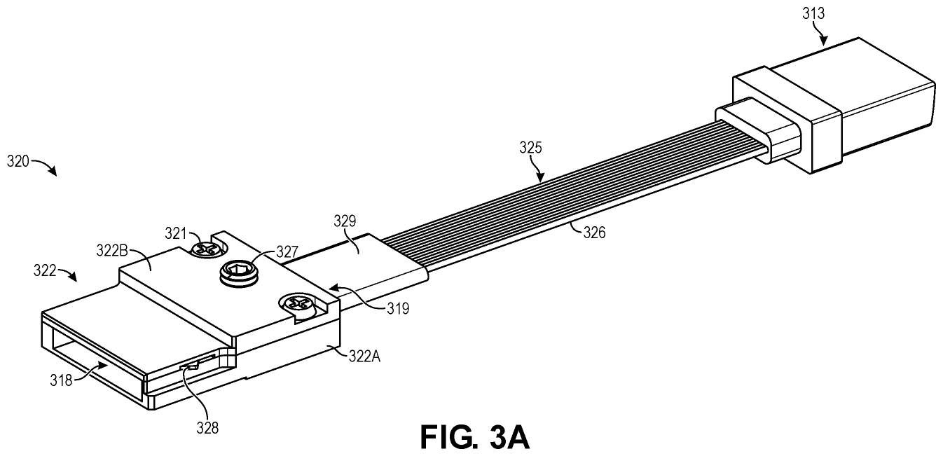

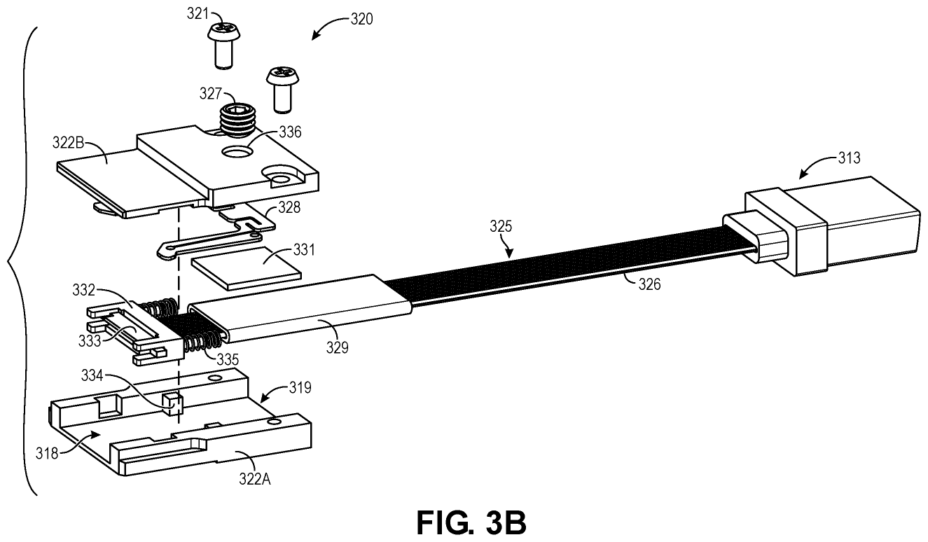

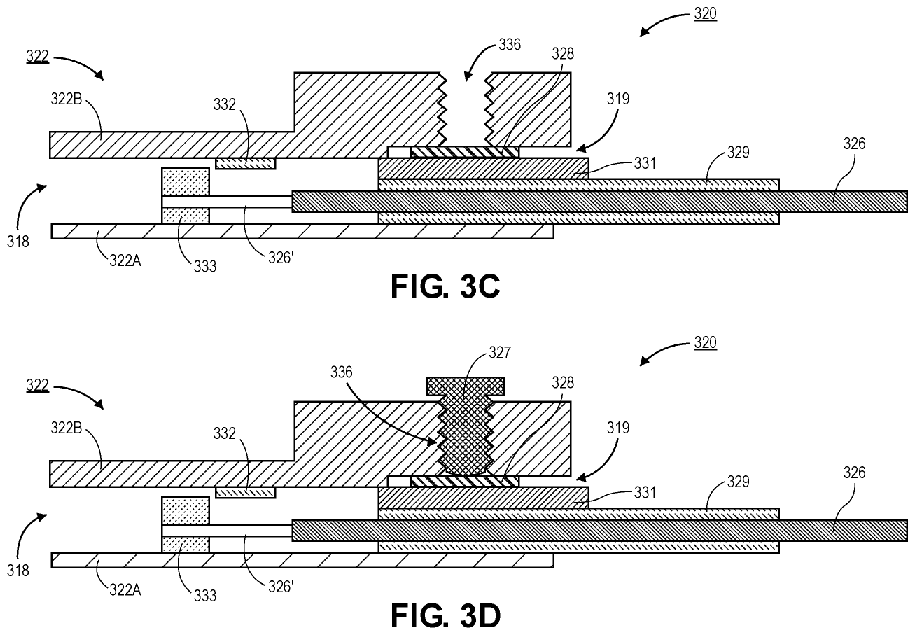

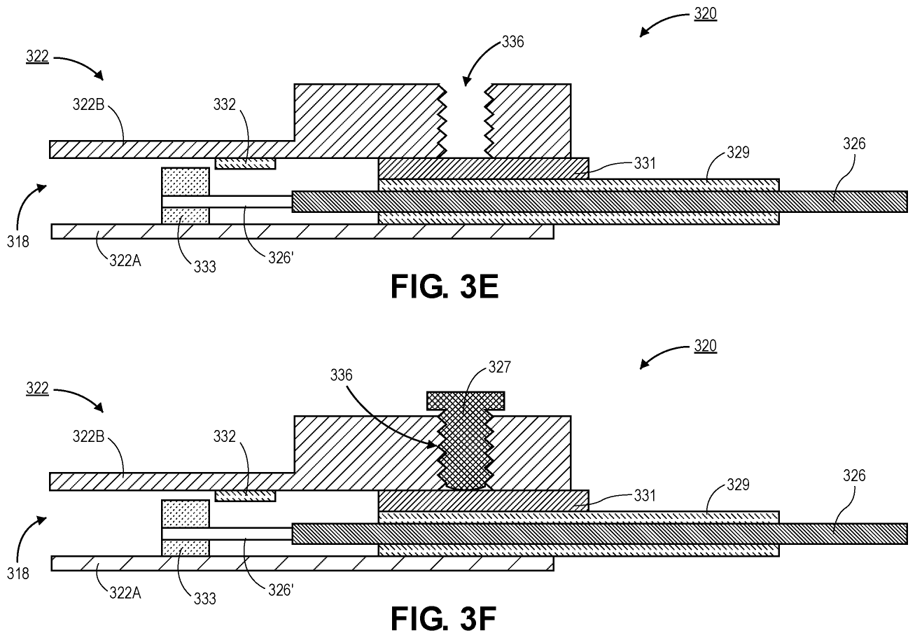

Referring now to FIGS. 3A-3F, a series of illustrations depicting connectors with a selectively applied strain relief feature is shown, in accordance with various embodiments. In an embodiment, the strain relief feature includes a screw. During the coupling process with the optical bridge, the screw is not tightened. This allows for the fibers to have longer effective lengths in order to reduce the mating force. After coupling, the screw can be engaged in order to fix the fibers in position within the connector. This prevents any bumping or movement of the fibers outside of the connecter from disrupting the optical coupling with the optical bridge.

Referring now to FIG. 3A, a perspective view illustration of a connector 320 is shown, in accordance with an embodiment. In an embodiment, the connector 320 may comprise a housing 322. The housing 322 may be a metallic material, a plastic material, or the like. In an embodiment, the housing 322 may comprise a lower housing 322A and an upper housing 322B (which may also be referred to as a lid). In an embodiment, the lower housing 322A and the upper housing 322B are mechanically coupled to each other. For example, screws 321 may mechanically couple the lower housing 322A to the upper housing 322B. Though, one or more other coupling features (e.g., snaps, clamps, magnets, etc.) may be used in combination with the screws 321 or as an alternative to the screws. It is to be appreciated that the screws 321 are used for mechanical coupling of the housing 322. That is, the screws 321 do not contact the fiber bundle 325 and/or apply any force to the fiber bundle 325. In an embodiment, the housing 322 may have a first opening 318 for receiving the optical bridge (not shown), and a second opening 319 to allow the fiber bundle 325 to enter the housing 322.

In an embodiment, the fiber bundle 325 may comprise a plurality of fibers 326. The fibers 326 may comprise glass fibers or any other material suitable for propagating optical signals. In an embodiment, the fibers 326 may be covered by a cladding, coating, or the like outside of the housing 322. The fiber bundle 325 may include any number of fibers 326, with the fibers 326 arranged in any number of rows. In an embodiment, a fiber jacket 329 may wrap around the fiber bundle 325. The fiber jacket 329 may extend into the housing 322 in some embodiments. The end of the fiber bundle 325 opposite from the housing 322 may be inserted into another connector 313, such as a MT connector or the like. In other embodiments, the other connector 313 may be similar to the connector 320.

In an embodiment, a slot along edges of the housing 322 may be provided in order to allow a portion of a latch spring 328 to protrude from the housing 322. The latch spring 328 may be used to temporarily affix the connector 320 to the optical bridge. The latch spring 328 can be released (e.g., by a pull tab—not shown) in order to release the connector 320 from the optical bridge. After the connector 320 is coupled to the optical bridge, a strain relief screw 327 may be inserted and/or tightened. As will be described in greater detail herein, the strain relief screw 327 presses down on the fiber bundle 325 in order to fix the fiber bundle 325 to a point within the housing 322.

Referring now to FIG. 3B, an exploded view of the connector 320 is shown, in accordance with an embodiment. As shown, the fiber bundle 325 may continue through an interior of connector 320 between the lower housing 322A and the upper housing 322B and terminate at the ferrule 333. The ferrule 333 may be similar to the ferrule 233 described in greater detail above. A holder 332 may secure the ferrule 333 and provide features to align the ferrule 333 with the optical bridge. Springs 335 may be provided behind the holder 332. When fully assembled, the back end of the springs 335 may sit against ledges 334 of the lower housing 322A. The springs 335 provide a sustained force against the holder 332 (and the ferrule 333) after the mechanical coupling with the optical bridge.

In an embodiment, a shim 331 may be provided over the jacket 329. The shim 331 may extend across all of the fibers 326 in the fiber bundle 325. As such, when force is applied to the shim 331 by the strain relief screw 327, the force is more evenly distributed in order to secure all of the fibers 326 within the fiber bundle 325. In an embodiment, the latch spring 328 may be provided over the shim 331 in some embodiments. A portion of the latch spring 328 may be underneath the hole 336 for the strain relief screw 327. As such, the strain relief screw 327 may contact a portion of the latch spring 328 instead of the shim 331 in some embodiments. In an embodiment, the hole 336 may be threaded to receive the strain relief screw 327.

Referring now to FIG. 3C, a cross-sectional illustration of the connector 320 with a hole 336 for the strain relief screw 327 is shown, in accordance with an embodiment. In FIG. 3C, the strain relief screw 327 has not yet been inserted. In this state, the connector 320 is able to be coupled to the optical bridge (not shown) with a low mating force. While the strain relief screw 327 is completely omitted from FIG. 3C, embodiments may also include a connector 320 with a strain relief screw 327 that is inserted into the hole 336, but not tightened down against the underlying fibers 326.

As shown, the housing 322 comprises a first opening 318 on the left side and a second opening 319 on the right side. The ferrule 333 is provided towards the first opening 318. In an embodiment, a bare glass fiber 326′ passes through a hole in the ferrule 333. A portion of the holder 332 is provided deeper into the housing 322 than the ferrule 333. The holder 332 contacts the ferrule 333 outside of the plane of FIG. 3C.

In an embodiment, a jacket 329 wraps around the fiber 326 out of the plane of FIG. 3C. The jacket 329 may be provided both inside and outside of the housing 322. While shown with a jacket 329, embodiments may also include fiber bundles 325 that are not wrapped in a jacket 329. The jacket 329 may also be provided only within the housing 322 in some embodiments. In an embodiment, the shim 331 is provided over the jacket 329. In the illustration of FIG. 3C, a portion of the latch spring 328 is also provided over the shim 331.

In an embodiment, the strain relief hole 336 is provided through a thickness of the upper housing 322B. The strain relief hole 336 may be threaded in order to receive the strain relief screw 327. As shown, a portion of the latch spring 328 and a portion of the shim 331 are located within a footprint of the strain relief hole 336.

Referring now to FIG. 3D, a cross-sectional illustration of the connector 320 after the strain relief screw 327 is inserted and engaged against the shim 331 is shown, in accordance with an embodiment. For example, tightening the strain relief screw 327 results in pressure being applied to the shim 331 (e.g., through a portion of the latch spring 328). The shim 331 then presses down on the fibers 326 in order to fix the position of the fibers 326 against the lower housing 322A. Accordingly, any movement or strain of the fibers 326 outside of the housing 322 is decoupled from the ferrule 333. This improves optical coupling efficiency during operation. The strain relief screw 327 may be engaged after the connector 320 is coupled to the optical bridge in order to maintain low mating force during the coupling.

Referring now to FIG. 3E, a cross-sectional illustration of a connector 320 is shown, in accordance with an additional embodiment. The connector 320 in FIG. 3E may be similar to the connector 320 in FIG. 3C with the exception of the presence of the latch spring. For example, the latch spring 328 is entirely outside of the plane of FIG. 3E. While not visible in FIG. 3E, the latch spring 328 may still be present within the connector 320. However, removal of the latch spring 328 from below the strain relief hole 336 allows for the latch spring 328 to be fully operational even when the strain relief screw is engaged. Without the presence of the portion of the latch spring 328, the shim 331 may be the first layer below upper housing 322B (within the plane of FIG. 3E).

Referring now to FIG. 3F, a cross-sectional illustration of the connector 320 after the strain relief screw 327 is inserted and engaged against the shim 331 is shown, in accordance with an embodiment. For example, tightening the strain relief screw 327 results in pressure being applied directly to the shim 331. The shim 331 then presses down on the fibers 326 in order to fix the position of the fibers 326 against the lower housing 322A. Accordingly, any movement or strain of the fibers 326 outside of the housing 322 is decoupled from the ferrule 333. This improves optical coupling efficiency during operation. The strain relief screw 327 may be engaged after the connector 320 is coupled to the optical bridge in order to maintain low mating force during the coupling.

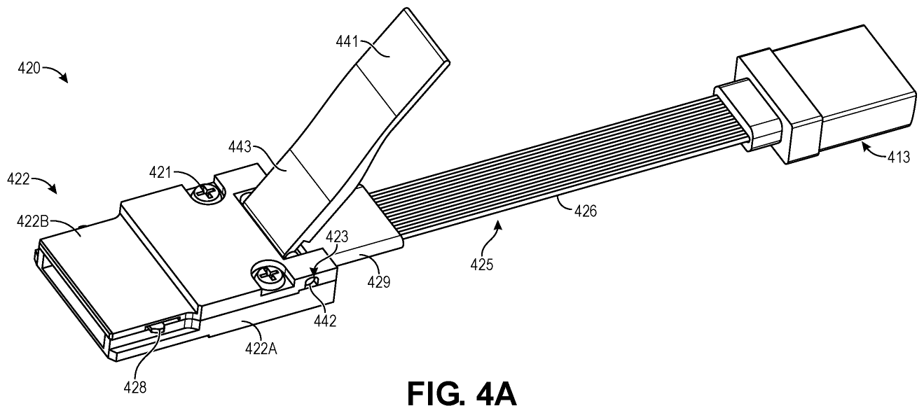

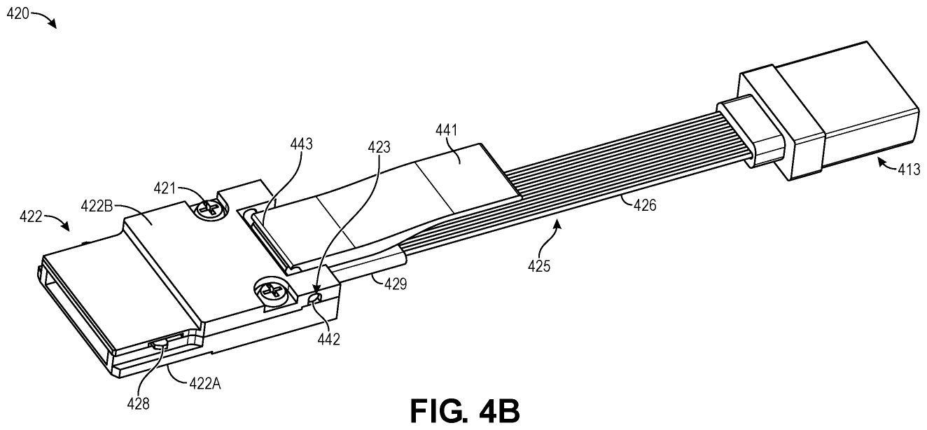

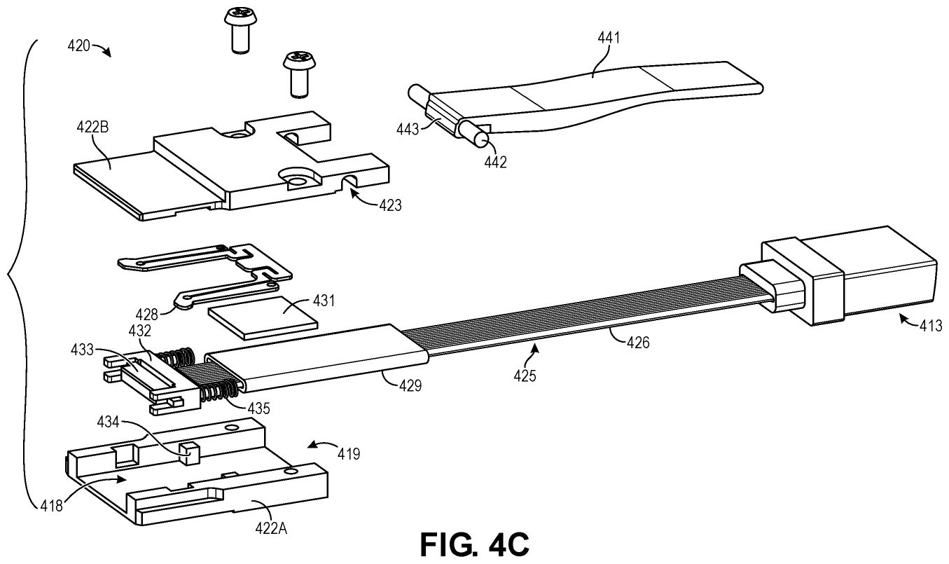

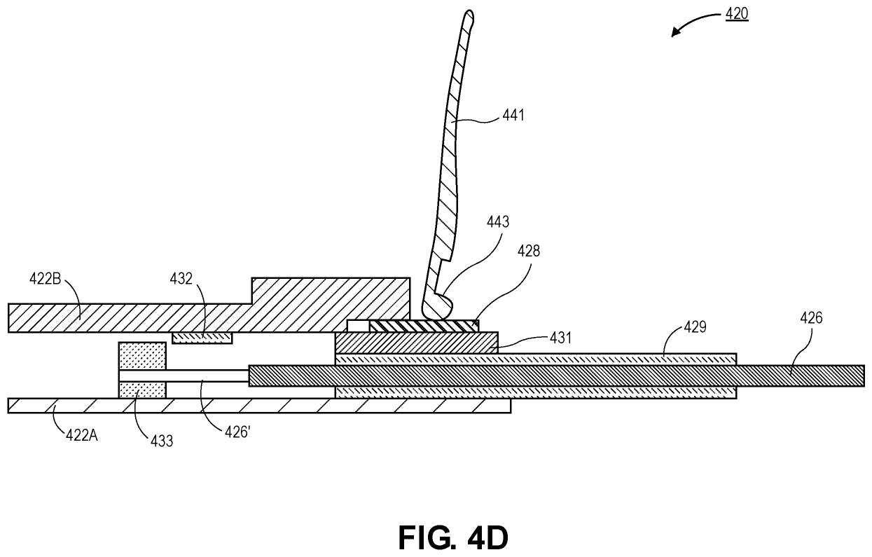

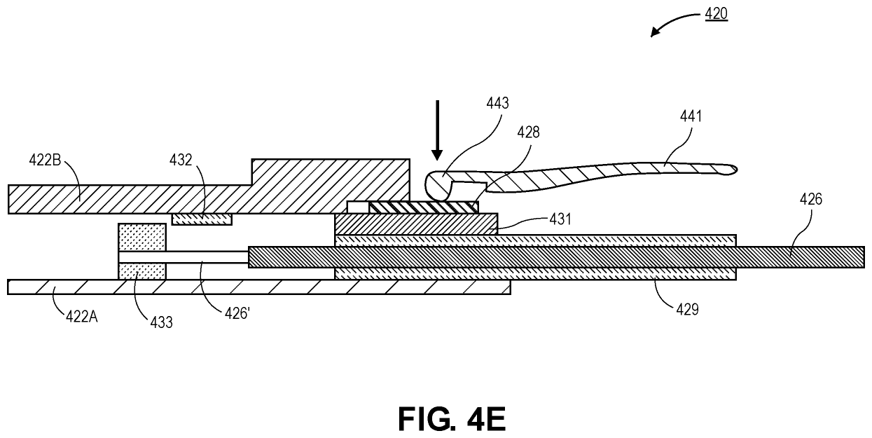

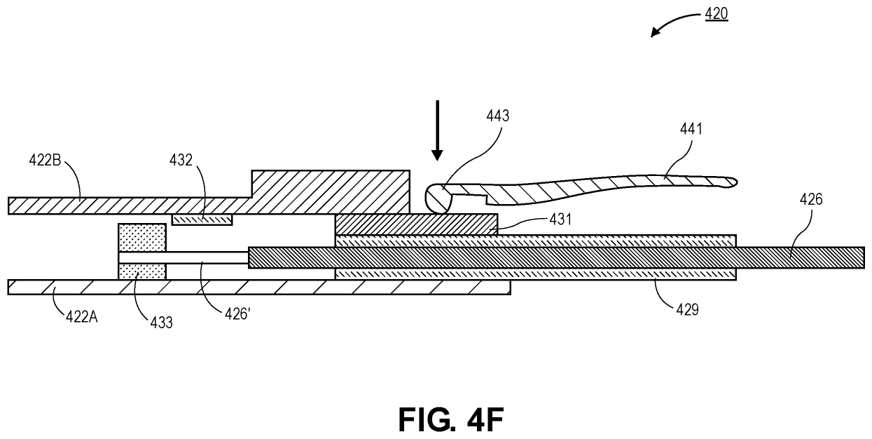

Referring now to FIG. 4A, a perspective view illustration of a connector 420 is shown, in accordance with an embodiment. In an embodiment, the connector 420 may comprise a housing 422. The housing 422 may be a metallic material, a plastic material, or the like. In an embodiment, the housing 422 may comprise a lower housing 422A and an upper housing 422B (which may also be referred to as a lid). In an embodiment, the lower housing 422A and the upper housing 422B are mechanically coupled to each other. For example, screws 421 may mechanically couple the lower housing 422A to the upper housing 422B. Though, one or more other coupling features (e.g., snaps, clamps, magnets, etc.) may be used in combination with the screws 421 or as an alternative to the screws. It is to be appreciated that the screws 421 are used for mechanical coupling of the housing 422. That is, the screws 421 do not contact the fiber bundle 425 and/or apply any force to the fiber bundle 425. In an embodiment, the housing 422 may have a first opening 418 for receiving the optical bridge (as shown in FIG. 4C), and a second opening 419 (as shown in FIG. 4C) to allow the fiber bundle 425 to enter the housing 422.

In an embodiment, the fiber bundle 425 may comprise a plurality of fibers 426. The fiber bundle 425 and the plurality of fibers 426 may be similar to any of the fiber bundles and/or fibers described in greater detail herein. In an embodiment, a fiber jacket 429 may wrap around the fiber bundle 425. The fiber jacket 429 may extend into the housing 422 in some embodiments. The end of the fiber bundle 425 opposite from the housing 422 may be inserted into another connector 413, such as a MT connector or the like. In other embodiments, the other connector 413 may be similar to the connector 420.

In an embodiment, a slot along edges of the housing 422 may be provided in order to allow a portion of a latch spring 428 to protrude from the housing 422. The latch spring 428 may be used to temporarily affix the connector 420 to the optical bridge. The latch spring 428 can be released (e.g., by a pull tab—not shown) in order to release the connector 420 from the optical bridge.

After the connector 420 is coupled to the optical bridge, a cam 443 may be engaged against the fiber bundle 425. In the illustrated embodiment, the cam 443 is engaged through the motion of a cam lever 441 that is attached to the cam 443. The cam lever 441 initiates rotation of the cam 443 about an axis that runs through a shaft 442 that is set into notches 423 in the upper housing 422B. In the illustration of FIG. 4A, the cam lever 441 is a raised position, and the cam 443 is not applying a downward force on the fiber bundle 425.

Referring now to FIG. 4B, a perspective view illustration of the connector 420 after the cam 443 is engaged in order to apply a downward force on the fiber bundle 425 is shown, in accordance with an embodiment. As shown, the cam 443 and the cam lever 441 are oriented so that the cam lever 441 is actuated in a plane along the length of the fiber bundle 425. For example, the axis of rotation through the shaft 442 may be substantially orthogonal to a length direction of the fiber bundle 425. However, other orientations of the cam 443 and/or the cam lever 441 may be used. For example, the cam lever 441 may actuate in a plane perpendicular to the length direction of the fiber bundle 425, or the cam lever 441 may actuate in a direction toward a front of the connector 420 (i.e., in a direction opposite from the direction shown in FIG. 4B). Additionally, while a cam lever 441 is used to actuate the cam 443 in FIGS. 4A and 4B, embodiments may include any mechanical structure or system to actuate the cam 443.

Referring now to FIG. 4C, an exploded view of the connector 420 is shown, in accordance with an embodiment. As shown, the fiber bundle 425 may continue through an interior of connector 420 between the lower housing 422A and the upper housing 422B and terminate at the ferrule 433. The ferrule 433 may be similar to the ferrule 233 described in greater detail above. A holder 432 may secure the ferrule 433 and provide features to align the ferrule 433 with the optical bridge. Springs 435 may be provided behind the holder 432. When fully assembled, the back end of the springs 435 may sit against ledges 434 of the lower housing 422A. The springs 435 provide a sustained force against the holder 432 (and the ferrule 433) after the mechanical coupling with the optical bridge.

In an embodiment, a shim 431 may be provided over the jacket 429. The shim 431 may extend across all of the fibers 426 in the fiber bundle 425. As such, when force is applied to the shim 431 by the cam 443, the force is more evenly distributed in order to secure all of the fibers 426 within the fiber bundle 425. In an embodiment, the latch spring 428 may be provided over the shim 431 in some embodiments. A portion of the latch spring 428 may be underneath the cam 443. As such, the cam 443 may contact a portion of the latch spring 428 instead of the shim 431 in some embodiments.

Referring now to FIG. 4D, a cross-sectional illustration of the connector 420 with a cam 443 and cam lever 441 for securing the fibers 426 is shown, in accordance with an embodiment. In FIG. 4D, the cam 443 has not yet been engaged against the shim 431. For example, the oblong surface of the cam 443 is rotated away from the shim 431. In this state, the connector 420 is able to be coupled to the optical bridge (not shown) with a low mating force. It is to be appreciated that the cam 443 in FIG. 4D is coupled to the upper housing 422B by a shaft (not shown) that runs through a center of cam 443. The shaft and the cam 443 may be a single monolithic structure in some embodiments. The shaft may be set into notches in the upper housing 422B in order to constrict motion of the cam 443 so that only rotational motion substantially about an axis of the shaft is allowed.

As shown, a bare glass fiber 426′ passes through a hole in the ferrule 433. A portion of the holder 432 is provided deeper into the housing 422 than the ferrule 433. The holder 432 contacts the ferrule 433 outside of the plane of FIG. 4D. In an embodiment, a jacket 429 wraps around the fiber 426 out of the plane of FIG. 4D. The jacket 429 may be provided both inside and outside of the housing 422. While shown with a jacket 429, embodiments may also include fiber bundles 425 that are not wrapped in a jacket 429. The jacket 429 may also be provided only within the housing 422 in some embodiments. In an embodiment, the shim 431 is provided over the jacket 429. In the illustration of FIG. 4D, a portion of the latch spring 428 is also provided over the shim 431. As shown, a portion of the latch spring 428 and a portion of the shim 431 are located below the cam 443.

Referring now to FIG. 4E, a cross-sectional illustration of the connector 420 after the cam 443 is engaged against the shim 431 by pulling down the cam lever 441 is shown, in accordance with an embodiment. Pulling down the cam lever 441 rotates the cam 443 so that the oblong portion is forced down against the shim 431 (e.g., through a portion of the latch spring 428), as indicated by the arrow. The shim 431 then presses down on the fibers 426 in order to fix the position of the fibers 426 against the lower housing 422A. Accordingly, any movement or strain of the fibers 426 outside of the housing 422 is decoupled from the ferrule 433. This improves optical coupling efficiency during operation. The cam 443 may be engaged after the connector 420 is coupled to the optical bridge in order to maintain low mating force during the coupling.

Referring now to FIG. 4F, a cross-sectional illustration of a connector 420 is shown, in accordance with an additional embodiment. The connector 420 in FIG. 4F may be similar to the connector 420 in FIG. 4E with the exception of the presence of the latch spring 428. For example, the latch spring 428 is entirely outside of the plane of FIG. 4F. While not visible in FIG. 4F, the latch spring 428 may still be present within the connector 420. However, removal of the latch spring 428 from below the cam 443 allows for the latch spring 428 to be fully operational even when the cam 443 is engaged against the shim 431. Without the presence of the portion of the latch spring 428, the shim 431 may be the first layer below upper housing 422B (within the plane of FIG. 4F).

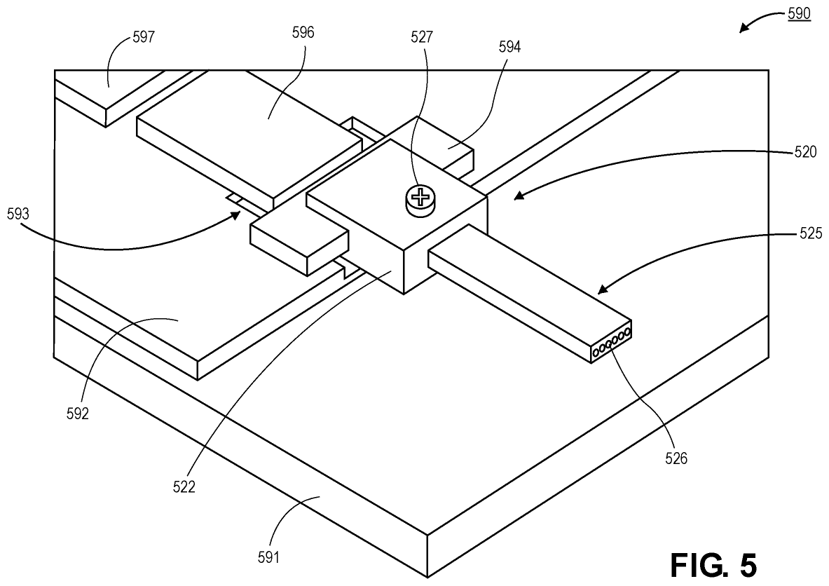

Referring now to FIG. 5, a perspective view illustration of a portion of an optoelectronic system 590 is shown, in accordance with an embodiment. The optoelectornic system 590 may comprise a board 591, such as a printed circuit board (PCB), a motherboard, or the like. The board 591 may be coupled to a package substrate 592 through second level interconnects (SLIs) (not visible in FIG. 5). The SLIs may comprise solder joints, pins, sockets, or the like.

In an embodiment, the optoelectronic system 590 may comprise a connector 520 for coupling a fiber bundle 525 with a plurality of fibers 526 to a PIC 596. The connector 520 may comprise a housing 522 that is configured to provided mechanical coupling to a receptacle 594 and optical coupling to an optical bridge (not visible) of the PIC 596. The receptacle 594 may sit across a recess 593 in the package substrate 592. In an embodiment, the connector 520 may be similar to any of the connectors described in greater detail herein. For example, the connector 520 may comprise a strain relief feature to fix a position of the fiber bundle 525 within the housing 522 after the optical and mechanical coupling is completed. In the example shown in FIG. 5, the strain relief feature is a strain relief screw 527. The strain relief screw 527 is tightened in order to press against the fiber bundle 525 within the housing 522. For example, a shim (not visible) within the housing 522 may distribute the force from the strain relief screw 527 across all of the fibers 526 within the fiber bundle 525. Other embodiments may include a cam as the strain relief feature, a magnet, a wedge, or any other suitable structure (or structures) that can selectively apply pressure to the fiber bundle 525 within the housing 522.

In an embodiment, the PIC 596 may convert optical signals to electrical signals and vice-versa. The PIC 596 may be communicatively coupled to a die 597 through electrical routing (not shown) within the package substrate 592. The die 597 may be configured to process data delivered along the optical fibers 526 and/or transmit data (after conversion to an optical signal by the PIC 596) along the optical fibers 526. The die 597 may be any type of die, such as a central processing unit (CPU), a graphics processing unit (GPU), an XPU, a communications die, a memory die, or the like. The PIC 596 and the die 597 may be coupled to the package substrate 592 through first level interconnects (FLIs) (not visible). The FLIs may include any suitable FLI architecture, such as solder bumps, copper bumps, hybrid bonding, and/or the like.

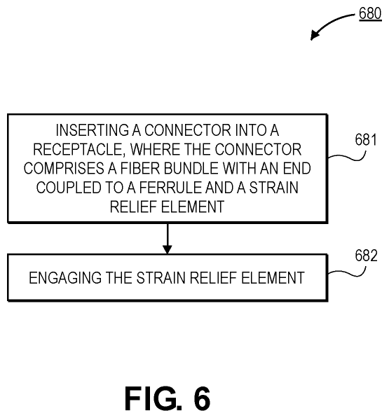

Referring now to FIG. 6, a process flow diagram of a process 680 for coupling a connector to an optical bridge is shown, in accordance with an embodiment. In an embodiment, the process 680 may begin with operation 681, which comprises inserting a connector into a receptacle. In an embodiment, the connector may comprise a fiber bundle with an end coupled to a ferrule and a strain relief element. In an embodiment, the connector may be similar to any of the connectors described in greater detail herein. For example, the strain relief element may include a screw, a cam, a wedge, a magnet, or the like. In an embodiment, the connector is inserted into the receptacle with the strain relief element unengaged.

In an embodiment, the process 680 may continue with operation 682, which comprises engaging the strain relief element. In an embodiment, engaging the strain relief element fixes the fiber bundled at a location within a housing of the connector. Accordingly, any movement, strain, or the like applied to the fiber bundle outside of the connector will not negatively impact the alignment of the ferrule with an optical bridge coupled to the receptacle. In an embodiment, engaging the strain relief element may include tightening a screw or actuating a cam (e.g., with a cam lever).

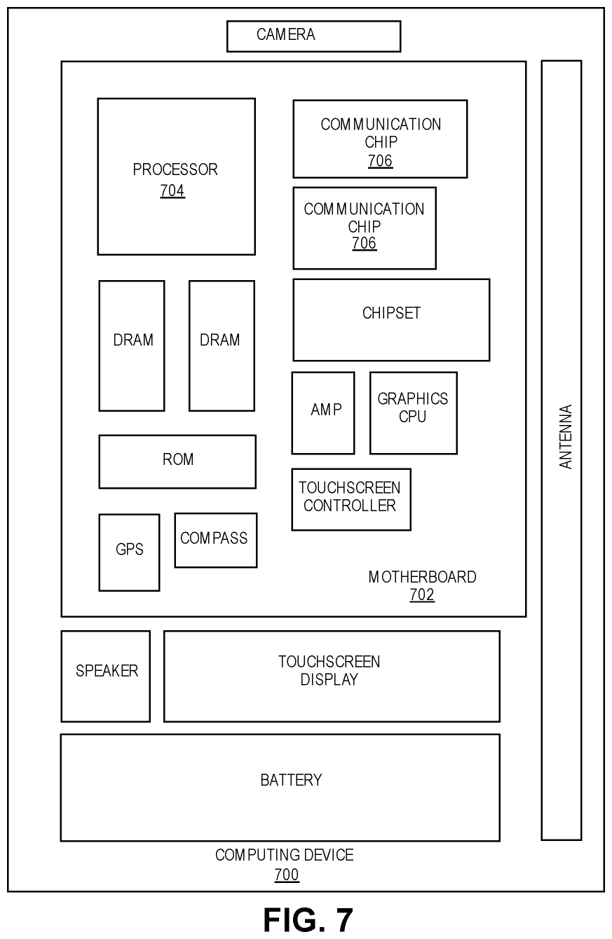

FIG. 7 illustrates a computing device 700 in accordance with one implementation of the disclosure. The computing device 700 houses a board 702. The board 702 may include a number of components, including but not limited to a processor 704 and at least one communication chip 706. The processor 704 is physically and electrically coupled to the board 702. In some implementations the at least one communication chip 706 is also physically and electrically coupled to the board 702. In further implementations, the communication chip 706 is part of the processor 704.

These other components include, but are not limited to, volatile memory (e.g., DRAM), non-volatile memory (e.g., ROM), flash memory, a graphics processor, a digital signal processor, a crypto processor, a chipset, an antenna, a display, a touchscreen display, a touchscreen controller, a battery, an audio codec, a video codec, a power amplifier, a global positioning system (GPS) device, a compass, an accelerometer, a gyroscope, a speaker, a camera, and a mass storage device (such as hard disk drive, compact disk (CD), digital versatile disk (DVD), and so forth).

The communication chip 706 enables wireless communications for the transfer of data to and from the computing device 700. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 706 may implement any of a number of wireless standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, 5G, and beyond. The computing device 700 may include a plurality of communication chips 706. For instance, a first communication chip 706 may be dedicated to shorter range wireless communications such as Wi-Fi and Bluetooth and a second communication chip 706 may be dedicated to longer range wireless communications such as GPS, EDGE, GPRS, CDMA, WiMAX, LTE, Ev-DO, and others.

The processor 704 of the computing device 700 includes an integrated circuit die packaged within the processor 704. In some implementations of the disclosure, the integrated circuit die of the processor may be part of an optical package that includes a fiber connector with a strain relief feature that can be selectively engaged, in accordance with embodiments described herein. The term “processor” may refer to any device or portion of a device that processes electronic data from registers and/or memory to transform that electronic data into other electronic data that may be stored in registers and/or memory.

The communication chip 706 also includes an integrated circuit die packaged within the communication chip 706. In accordance with another implementation of the disclosure, the integrated circuit die of the communication chip may be part of an optical package that includes a fiber connector with a strain relief feature that can be selectively engaged, in accordance with embodiments described herein.

In an embodiment, the computing device 700 may be part of any apparatus. For example, the computing device may be part of a personal computer, a server, a mobile device, a tablet, an automobile, or the like. That is, the computing device 700 is not limited to being used for any particular type of system, and the computing device 700 may be included in any apparatus that may benefit from computing functionality.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize.

These modifications may be made to the disclosure in light of the above detailed description. The terms used in the following claims should not be construed to limit the disclosure to the specific implementations disclosed in the specification and the claims. Rather, the scope of the disclosure is to be determined entirely by the following claims, which are to be construed in accordance with established doctrines of claim interpretation.

Example 1: an apparatus, comprising: a housing with a first opening at a first end of the housing and a second opening at a second end of the housing; a ferrule within the housing, wherein the ferrule comprises a plurality of holes; a plurality of fibers in the housing, wherein individual ones of the plurality of fibers are inserted into different ones of the plurality of holes in the ferrule; a shim across the plurality of fibers; and a third opening in the housing, wherein the third opening is over the shim.

Example 2: the apparatus of Example 1, wherein the third opening is threaded, and wherein a screw passes through the third opening and presses against the shim.

Example 3: the apparatus of Example 1 or Example 2, further comprising: a jacket around the plurality of fibers, wherein the shim contacts the jacket.

Example 4: the apparatus of Examples 1-3, further comprising a latch spring within the housing, wherein a portion of the latch spring is between the shim and the third opening.

Example 5: the apparatus of Examples 1-4, wherein the housing comprises: a lower housing; and an upper housing, wherein the lower housing is mechanically coupled to the upper housing.

Example 6: the apparatus of Examples 1-5, wherein the ferrule is retained by a holder within the housing.

Example 7: the apparatus of Example 6, further comprising: a spring between a surface of the holder and an internal ledge of the housing.

Example 8: the apparatus of Examples 1-7, wherein the apparatus is a connector configured to optically couple the plurality of fibers to a photonics system.

Example 9: the apparatus of Example 8, wherein the photonics system is a photonics integrated circuit (PIC).

Example 10: the apparatus of Example 9, wherein the PIC is electrically coupled to a processor through electrical routing in a package substrate, and wherein the package substrate is coupled to a board.

Example 11: an apparatus, comprising: a housing with a first opening at a first end of the housing and a second opening at a second end of the housing; a ferrule within the housing, wherein the ferrule comprises a plurality of holes; a plurality of fibers in the housing, wherein individual ones of the plurality of fibers are inserted into different ones of the plurality of holes in the ferrule; a shim across the plurality of fibers; and a cam mechanically coupled to the housing, wherein the cam is rotatable about an axis in order to increase or decrease a force applied to the shim.

Example 12: the apparatus of Example 11, wherein the cam directly contacts the shim.

Example 13: the apparatus of Example 11 or Example 12, further comprising: a latch spring between the shim and the cam.

Example 14: the apparatus of Examples 11-13, wherein the cam is coupled to the housing by a shaft that is set into a first notch and a second notch of the housing, wherein the first notch and the second notch are on opposite sides of the cam.

Example 15: the apparatus of Examples 11-14, wherein the cam is actuated by a lever.

Example 16: the apparatus of Examples 11-15, further comprising: a jacket around the plurality of fibers, wherein the shim contacts the jacket.

Example 17: the apparatus of Examples 11-16, wherein the apparatus is a connector configured to optically couple the plurality of fibers to a photonics system.

Example 18: an apparatus, comprising: a housing; a plurality of fibers in the housing; and a shim across the plurality of fibers, wherein the shim is between the plurality of fibers and the housing; and a strain relief feature configured to selectively apply force against the shim in order to secure the plurality of fibers between the shim and the housing.

Example 19: the apparatus of Example 18, wherein the strain relief feature is a screw, a cam, a magnet, or a wedge.

Example 20: the apparatus of Example 18 or Example 19, wherein the apparatus is a connector configured to optically couple the plurality of fibers to an optical bridge.

What is claimed is:

1. An apparatus, comprising:
a housing with a first opening at a first end of the housing and a second opening at a second end of the housing;
a ferrule within the housing, wherein the ferrule comprises a plurality of holes;
a plurality of fibers in the housing, wherein individual ones of the plurality of fibers are inserted into different ones of the plurality of holes in the ferrule;
a shim across the plurality of fibers; and
a third opening in the housing, wherein the third opening is over the shim.

2. The apparatus of claim 1, wherein the third opening is threaded, and wherein a screw passes through the third opening and presses against the shim.

3. The apparatus of claim 1, further comprising:
a jacket around the plurality of fibers, wherein the shim contacts the jacket.

4. The apparatus of claim 1, further comprising a latch spring within the housing, wherein a portion of the latch spring is between the shim and the third opening.

5. The apparatus of claim 1, wherein the housing comprises:
a lower housing; and
an upper housing, wherein the lower housing is mechanically coupled to the upper housing.

6. The apparatus of claim 1, wherein the ferrule is retained by a holder within the housing.

7. The apparatus of claim 6, further comprising:
a spring between a surface of the holder and an internal ledge of the housing.

8. The apparatus of claim 1, wherein the apparatus is a connector configured to optically couple the plurality of fibers to a photonics system.

9. The apparatus of claim 8, wherein the photonics system is a photonics integrated circuit (PIC).

10. The apparatus of claim 9, wherein the PIC is electrically coupled to a processor through electrical routing in a package substrate, and wherein the package substrate is coupled to a board.

11. An apparatus, comprising:
a housing with a first opening at a first end of the housing and a second opening at a second end of the housing;
a ferrule within the housing, wherein the ferrule comprises a plurality of holes;
a plurality of fibers in the housing, wherein individual ones of the plurality of fibers are inserted into different ones of the plurality of holes in the ferrule;
a shim across the plurality of fibers; and
a cam mechanically coupled to the housing, wherein the cam is rotatable about an axis in order to increase or decrease a force applied to the shim.

12. The apparatus of claim 11, wherein the cam directly contacts the shim.

13. The apparatus of claim 11, further comprising:
a latch spring between the shim and the cam.

14. The apparatus of claim 11, wherein the cam is coupled to the housing by a shaft that is set into a first notch and a second notch of the housing, wherein the first notch and the second notch are on opposite sides of the cam.

15. The apparatus of claim 11, wherein the cam is actuated by a lever.

16. The apparatus of claim 11, further comprising:
a jacket around the plurality of fibers, wherein the shim contacts the jacket.

17. The apparatus of claim 11, wherein the apparatus is a connector configured to optically couple the plurality of fibers to a photonics system.

18. An apparatus, comprising:
a housing;
a plurality of fibers in the housing; and
a shim across the plurality of fibers, wherein the shim is between the plurality of fibers and the housing; and
a strain relief feature configured to selectively apply force against the shim in order to secure the plurality of fibers between the shim and the housing.

19. The apparatus of claim 18, wherein the strain relief feature is a screw, a cam, a magnet, or a wedge.

20. The apparatus of claim 18, wherein the apparatus is a connector configured to optically couple the plurality of fibers to an optical bridge.
